(19) United States
(12) Patent Application Publication
(10) Pub. No.: US 2007/0101092 A1
(43) Pub. Date: May 3, 2007

(54) MULTI-PAGE ADVERTISING MEDIUM AND SYSTEM FOR USE

(75) Inventors: Allan D. OTTMANN, Canmore, AB (CA); Wayne E. UNRUH, Regina, SK (CA)

Correspondence Address: SEAN W. GOODWIN, 222 PARKSIDE PLACE, 602-12 AVENUE S.W., CALGARY, AB, T2R 1J3, CA

(73) Assignee: ALLAN D MEDIA INC., Canmore (CA)

(21) Appl. No.: 11/428,291

(22) Filed: Jun. 30, 2006

Related U.S. Application Data
(60) Provisional application No. 60/597,067, filed on Nov. 8, 2005.

(30) Foreign Application Priority Data
Nov. 3, 2005 (CA) 2525284

(51) Int. Cl. G06F 12/00

(52) U.S. Cl. 711/170; 705/14

(57) ABSTRACT

A strip of multi-page booklets of coupons are printed so that each booklet of coupons can be removed from the strip at lines of perforations formed between the booklets. Thus, the consumer can remove the booklets and carry the booklets with them for use. Each of the booklets represents a single retailer or service provider and has multiple pages of coupons.

### CROSS REFERENCE TO RELATED APPLICATIONS

This application is a regular US patent application claiming priority of pending U.S. Provisional Patent application Ser. No. 60/597,067, filed Nov. 8, 2005, the entirety of which is incorporated herein by reference.

### FIELD OF THE INVENTION

Embodiments of the invention relate to a multi-page advertising product for distribution to the public and more particularly to a plurality of multi-page coupon booklets produced as a unitary strip of booklets, each booklet being perforated for removal from the unitary strip as a discrete booklet of coupons typically related to a single retailer or the like.

### BACKGROUND OF THE INVENTION

It is well known in the retail industry to provide coupons to the public, offering services, products and the like as a means of advertising and encouraging consumers to utilize a particular service and product in the hopes of obtaining continued and ongoing sales to the consumer. Coupons may be provided singly however it is also common to provide multiples of coupons connected to one another or to another medium so as to prevent coupons from being lost, to facilitate ease of delivery and to allow cost effective distribution.

Conventional coupons are typically distributed in a number of formats including multi-page booklets containing coupons related to a single retailer or service provider typically delivered as a single booklet, flyers, single panel perforated strips, compilations bound in a digest or book format and as single page advertisements in magazines as well as on free standing inserts delivered in newspapers and the like. Often single retailer booklets are created using a stapled spine and the coupons may or may not be perforated for ease of removal. Conventional booklets containing one or more coupons are frequently provided to the consumer at the retail outlet or through distribution to the consumer, such as at their residence, typically as a result of mailing or direct delivery. In the case of large conventionally bound coupon books, the coupons must typically be removed through perforations adjacent the spine of the book as well across the width of the book.

Alternatively, it is known to provide a single sheet of coupons which can be perforated for removal of each coupon from the sheet of coupons. Such coupons may be for a single retailer or may be from a compilation of retailers and service providers and are generally printed and distributed by a single advertising provider. The sheet of coupons may be a single sheet, such as an 8½×11″ sheet or may be in the form of an elongate strip of coupons, such as business card sized coupons, which can be delivered into mail boxes and the like or hung on a doorknob.

Methods for systems of the subscription of retailers and for the service providers and production and distribution of coupons are known. U.S. Pat. No. 6,572,149 to Long describes as system in which a subscribing business establishes a business relationship with the coupon distributor who identifies recipients, including their preferences and mailing addresses, and who have coupons printed which are foldable to display the mailing address of the recipient thereon. The coupons further display a map and instructions for using the coupons and for obtaining additional coupons.

There is interest in the industry to provide unique advertising products which would provide the consumer with an advertising product that can be easily retained for redemption. Such advertising products should be economical to produce and should be easily distributed. Further, there is interest in establishing unique means for subscription of retailers and service providers and distribution of the advertising product to the consumer.

### SUMMARY OF THE INVENTION

A unique multi-page advertising medium comprises a strip of multi-page coupon booklets separated from one another by lines of perforation such that a consumer to whom the strip has been delivered can remove an entire booklet from an advertiser of interest by tearing the entire booklet from the strip at a line of perforation and carry the multiples of coupons contained therein in a compact and organized manner.

In one embodiment a top portion of the strip is cut, such as by die cutting, with an opening suitable to permit the strip to be hung on a projection such as a doorknob for delivery of the advertising medium to the consumer.

Thus is a broad aspect of the invention, a multi-page advertising medium comprises: an elongate multi-page strip having an elongate spine edge and an elongate open edge, the strip formed having two or more discrete multi-page booklets, each discrete multi-page booklet of the two or more multi-page booklets being separated by a line of perforations formed substantially transversely across and through a width of the strip, each discrete multi-page booklet being removeable from an adjacent multi-page booklet at the line of perforations therebetween.

In on embodiment, the advertising medium is finished in an on-line process after printing a substantially continuous web stock using heat-set web offset lithography and perforating the stock at predetermined intervals. Multiple pages are created by applying a line of adhesive and folding the continuous web to the width of a single booklet. The number of pages is generally governed by the width of the stock and the number of times the adhesive is applied and the stock is folded. An opening is cut, typically using a die-cutting process, at predetermined intervals along the folded stock to provide openings in each of the strips once they are cut from the continuous folded stock. The finish-folded stock is then cut into the strips containing two or more booklets having a line of perforation therebetween.

Alternately, the advertising medium can be produced using a sheet fed press and off-line finishing using a variety of post-printing finishing equipment. In this embodiment each sheet is substantially the length of the strip and the perforating process is typically performed after the stock has been finish-folded.

Thus in another broad aspect of the invention, a method for the multi-page advertising medium comprises: printing stock on at least one side; perforating the stock transversely across a width of the stock at predetermined spaced intervals; applying a first line of an adhesive longitudinally along a length of the stock at a position substantially a width of a booklet from a first longitudinal edge of the stock; folding the stock along substantially in half for forming a folded multi-page stock having pages adhesively bonded at the first line of adhesive; folding the folded multi-page stock in half for forming a finish-folded multi-page stock having a spine edge substantially along the line of adhesive opposing the first longitudinal edge; and trimming the finish-folded multi-page stock longitudinally along the first longitudinal edge for opening the pages of the multi-page stock.

### BRIEF DESCRIPTION OF THE DRAWINGS

FIGS. 1-6 illustrate a process for printing a multi-page advertising product according to an embodiment of the invention; more particularly;

FIG. 1 illustrates a continuous web of paper printed on one or both sides with indicia unique to coupons to be contained in the multi-page advertising product;

FIG. 2 illustrates the continuous web of FIG. 1 having been perforated across the web at predetermined intervals for forming perforations between coupons contained thereon;

FIG. 3 illustrates a line of glue laid down along a length of the web for forming a glued spine of the advertising product;

FIG. 4 illustrates a fold formed along the length of the web for creating the plurality of pages of the advertising product;

FIG. 5 illustrates a second fold formed along the glued spine of the product for forming the advertising product, the product being trimmed along a first edge for opening the pages contained therein; and

FIG. 6 illustrates the process of trimming the head and foot of each of the advertising products, separating each individual completed multi-page advertising product from the continuous web;

FIG. 7 is a perspective front view of the multi-page advertising product according to an embodiment of the invention and produced according to FIGS. 1-6, the indicia printed thereon being removed for clarity;

FIG. 8 illustrates a continuous web having been passed through a dye-cutter to cut a horseshoe opening at a top of each of the advertising products contained therein for permitting the product to be hung on a doorknob;

FIG. 9 is a perspective front view of the multi-page advertising product according to an embodiment of the invention and produced according to FIGS. 1-6 and 8, the indicia printed thereon being removed for clarity;

FIG. 10 is a perspective front view of the multi-page advertising product according to FIG. 9, illustrating a coupon booklet having been removed along a set of matched perforations on each page contained therein, the indicia printed thereon being removed for clarity; and

FIG. 11 is a schematic illustrating a direct advertising and distribution system using the product according to FIGS. 7 and 9.

### DETAILED DESCRIPTION OF THE PREFERRED EMBODIMENTS

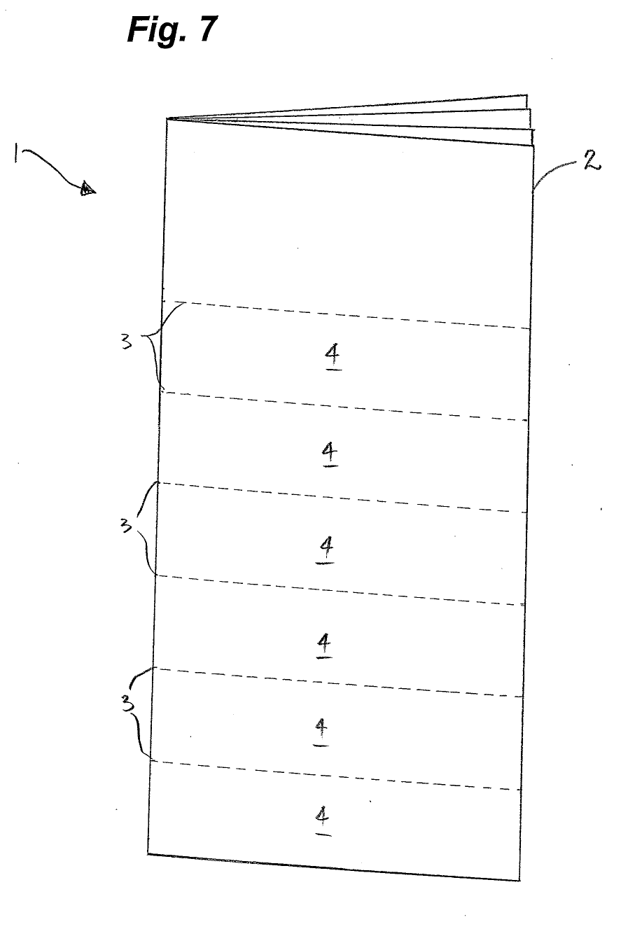

As shown in FIGS. 7, 9 and 10, a unique advertising product 1 comprises an elongate strip 2 containing a plurality of pages which are perforated 3 into a plurality of multi-page booklets 4. Preferably, each of the pages in each of the booklets 4 are printed on both sides and each of the booklets 4 contains a plurality of coupons 5 unique to an individual advertiser A, B . . . , such as a retailer or service provider. Thus, each booklet 4 containing the plurality of coupons 5 can be torn from the strip 2, as desired, and only coupons of interest to the consumer can be carried for use thereafter.

One cost effective process for producing the multi-page tear off booklet strips 2 is printing using heat-set web offset lithography followed by on-line finishing. One press suitable for performing said printing is a Royal Zenith 420 press, available throughout the USA.

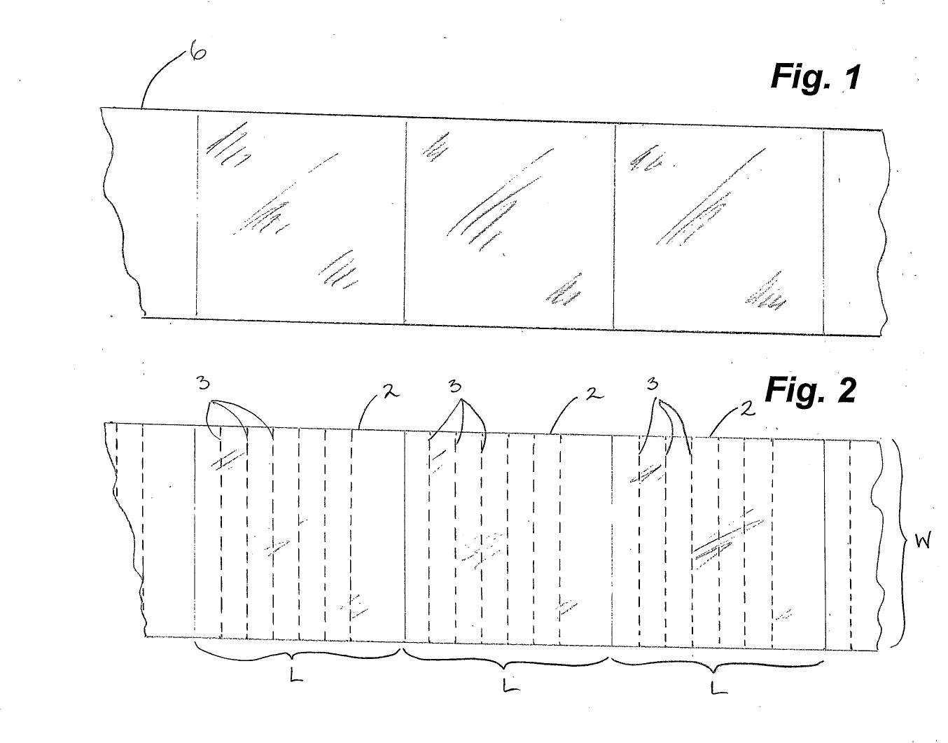

In one embodiment, according to FIGS. 1-6, blank rolls of 23 inch #3 grade web gloss 80 lb. stock are loaded onto roll stands and the press is webbed therefrom. Plates containing the advertising artwork to be printed onto the coupon booklets 4 are loaded on blanket to blanket perfecting web printing units, each plate and printing unit printing in a single color to both sides of the stock as it passes therethrough. Conventionally, 4-color printing employs cyan, magenta, yellow and black (CMYB) to produce the color gradations in such printing processes. Following printing, the stock 6 is passed through a drying oven which evaporates volatile solvents from the ink leaving a semi-dry ink film. Chill rolls in the press cool the heated stock and set the ink onto the stock.

The printed continuous stock 6, as shown in FIG. 1, is then passed through a conventional perforating unit which perforates the stock 6 transversely across a width W of the stock 6 spaced at a plurality of locations or intervals to produce the lines of perforations 3 which will ultimately permit the discrete booklets 4 to be torn from the strip of booklets 2 (FIG. 2), once completed. As shown, the stock 6 can be perforated with six lines of perforations 3 for each length L of product 1 which corresponds to a strip of booklets 2 having six discrete booklets 4. Due to the cross-width or transverse perforations 3, care is taken in adjusting the tension of the stock 6 as it passes through the finishing process to ensure the continuous printed and perforated stock 6 is maintained intact until the process is completed. Preferably, the advertising artwork or indicia for each advertiser printed on the stock 6 generally falls between successive lines of perforations 3 so as to result in a discrete booklet 4 for each advertiser.

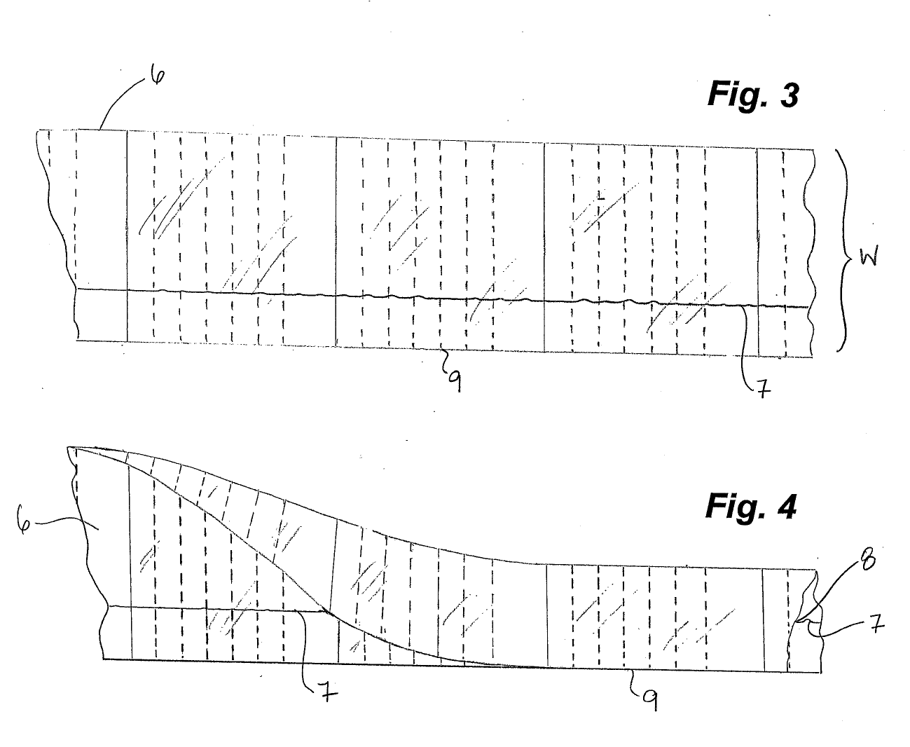

Following perforation (FIG. 3), the printed stock 6 is passed through a cold glue applicator unit which lays down a line of adhesive or glue 7 longitudinally along the length of the printed stock 6 at a predetermined position, typically being substantially the width of a single booklet 4 from a first longitudinal edge 9 of the stock.

In the case of a four page booklet 4, the glue is typically positioned at about ¾ of the width W of the stock 6 or ¼ the width from the first edge 9. Once the glue 7 has been applied, the printed stock 6 enters a first plow fold station which folds the printed stock 6 substantially in half (FIG. 4) over the line of glue 7 to engage the glue and create a glued spine 8 and 4 double-sided pages. The width of the web folded to engage the glue 7 is substantially the width of two finished booklets 4.

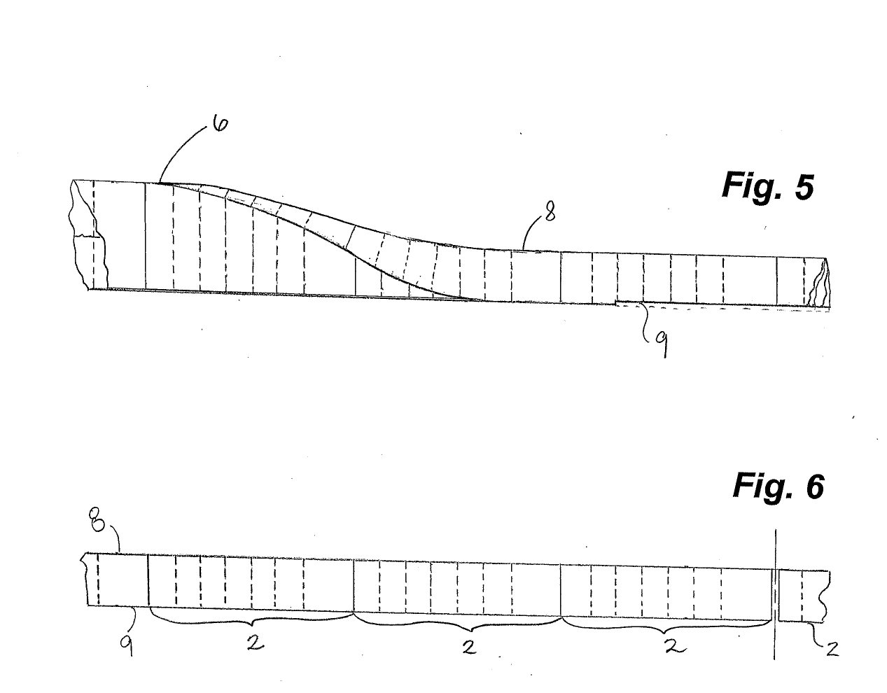

As shown in FIG. 5, the folded stock 6 is passed through a second plow fold station and is folded substantially in half again, this finishing fold being along the glued spine 8 for creating a finished width, 4-page product, all pages being glued along the spine 8. Further, the first edge 9 of the finish-folded stock 6, opposing the glued spine 8, is trimmed for opening the pages of the multi-page advertising product 1.

In the case of eight page booklets (not shown), a larger width (W) web stock 6 is required and the application of the line of adhesive 7 and the folding in half is repeated once more before the finish folding along the glued spine 8 and the trimming is done. The first line of adhesive 7, positioned substantially a booklet width from the first edge 9, is at about ⅞ of the entire width of the web stock 6 or ⅛ of the width from the first edge 9. The stock 6 is folded in half and a second line of adhesive is applied at a booklet width or ¼ of the width from the first edge 9, As in the case of the four page booklet embodiment, the stock 6 is folded in half again to engage the glue and the multiple pages at the spine 8 and the finish folding is then done to result in a thrice-folded finished multi-page length of perforated web stock 6. As with the four page embodiment, the first edge 9 opposing the glued spine is trimmed for opening the pages.

Greater numbers of pages can be added by increasing the width of the web stock 6 and the number of times the lines of adhesive 7 are laid down and the first folding in half to engage the adhesive are performed, prior to the finish folding. Each time the adhesive 7 is positioned at substantially a booklet width from the first edge 9.

Having reference to FIGS. 6 and 7, once the pages have been opened by trimming, the head and foot of each strip 2 is trimmed using a variable sized sheeter resulting in a plurality of finished strips 2 of booklets 4 (FIG. 7) being severed from the continuous length of folded and glued product.

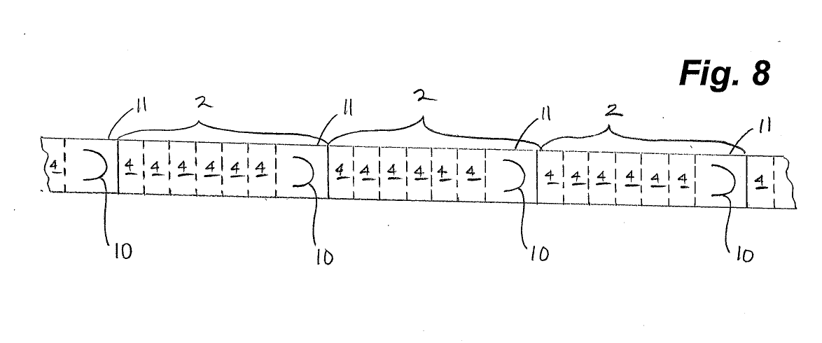

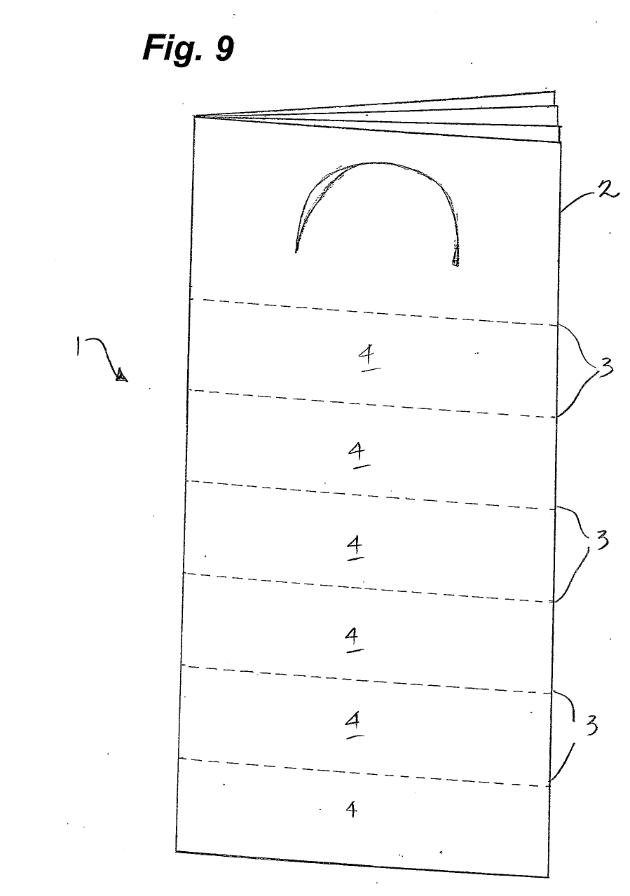

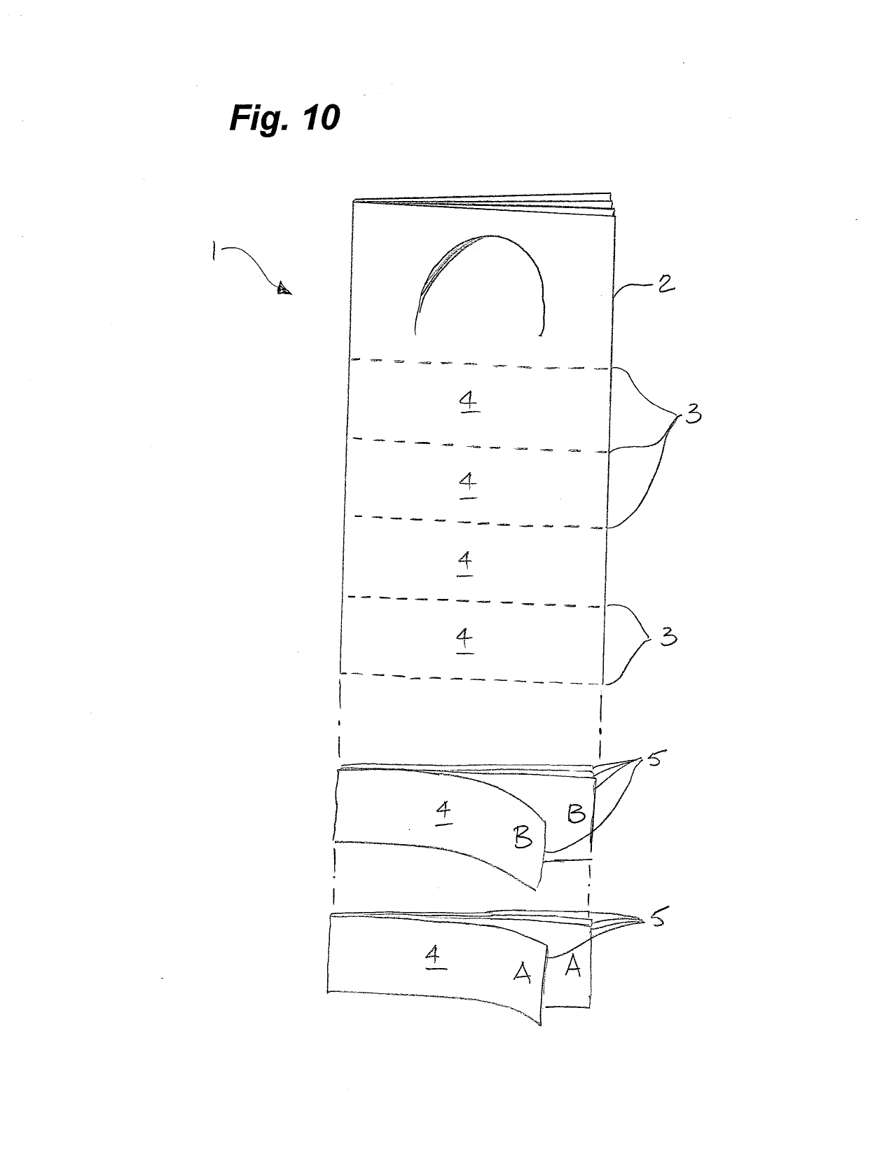

Optionally, as shown in FIG. 8, a shaped opening 10, such as a horseshoe shaped opening, may be cut through a top 11 of each strip 2 of booklets 4 prior to trimming the head (top) and foot (bottom) of each strip 2 to permit each strip 2 to be hung on a doorknob or other projection during delivery. The continuous finish-folded stock 6 is passed through a die cutter which is configured to cut the shaped opening 10 in the top 11 of each strip 2 of booklets 4 after which the stock 6 is passed through the variable sized sheeter to trim the head and foot and complete the process and produce the multi-page advertising product 1 according to FIGS. 9 and 10.

Production of the multi-page advertising product may be accomplished through a variety of conventional printing equipment using an online finishing process. Thus, an economically viable and unique multi-page advertising product can be produced for distribution.

Alternately, in another embodiment, the multi-page advertising medium 1 may be produced using a sheet fed printing process wherein the length of each piece of sheet stock 6 corresponds to the length of a strip of booklets 2 in the continuous web process discussed above. In this embodiment, a printing press such as a Komori 6 color printing press, available from Komori Corporation, Japan, could be used to print indicia on one or both sides of single sheets of stock. Each single sheet produces a strip 2 of discrete booklets 4. The printed sheets are removed from the press after printing the second side and are loaded on a folding machine, such as a Stahl folder (available throughout the USA), which can be configured to apply a line of glue as described above and to fold each sheet as many times as are required to achieve a finished width, being typically the width of a single booklet 4. The folding machine may also be configured to perforate the folded sheet transversely across the entire width of the folded sheet including the spine 8 and further, to die-cut an opening in the strip 2 to permit hanging the strip 2 on a projections, such as a doorknob.

Alternately, the folded sheets are transferred from the folder to a separate print finishing machine or series of machines such as those available from Rosback Co. (St. Joseph, Mich., USA), Bobst (Bobst Group USA Inc. Charlotte N.C., USA or Bobst Group Canada Inc. Pointe-Claire QU, Canada) or Heidelberg (Baumfolder Corporation, Sidney Ohio, US), which are converted to perforate and die-cut the folded stock as described herein.

Following perforation, and optionally die-cutting, the folded stock is transferred to a guillotine or cutting machine to be trimmed as described above for opening the pages for forming the final multi-page advertising medium 1.

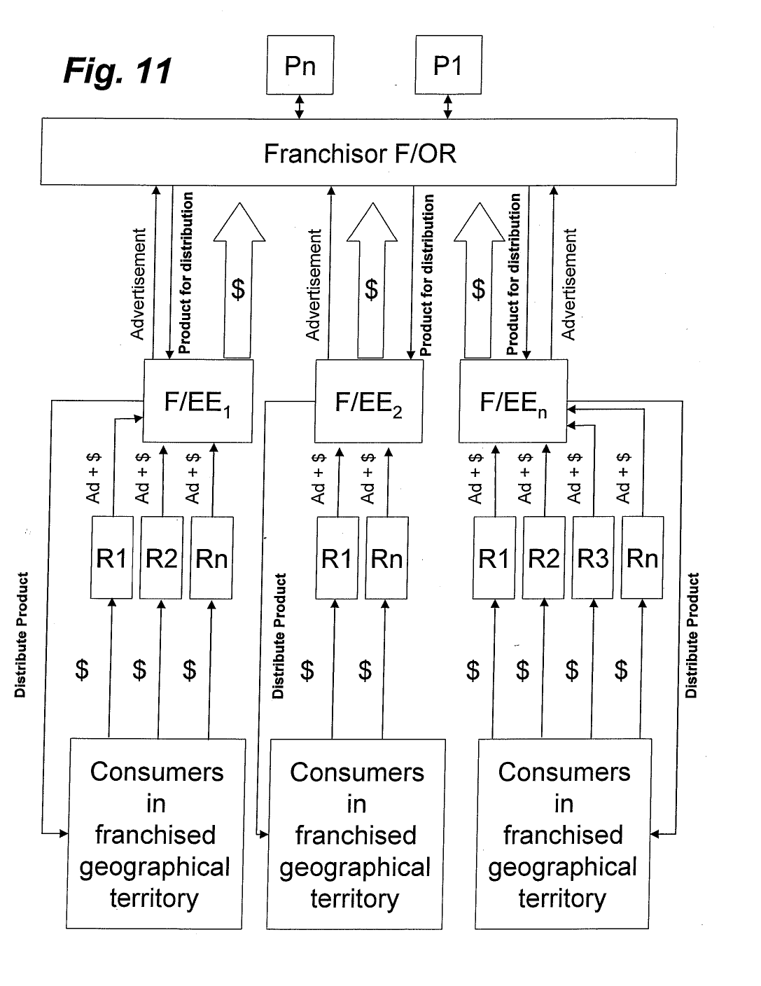

Having reference to FIG. 11, an embodiment of a system for production and distribution of the unique advertising product described herein is shown. The embodiment disclosed herein is described in the context of a franchised system however additional embodiments are contemplated using a licensed system wherein a licensor establishes a business relationship with a plurality of licensees and therefore the description which follows should not be limited to a franchised system only.

A single franchiser F/OR, who is responsible for the production of the unique advertising product according to embodiments disclosed herein, establishes a business relationship with a plurality of franchisees F/EE₁ . . . F/EEₙ each of whom are responsible for selling direct marketing advertising to a plurality of advertisers or customers such as retailers, service providers and the like R1 . . . Rn within their individual franchised geographical territories. The franchisees F/EE₁ . . . F/EEₙ are also responsible for establishing and financing a distribution or delivery network to deliver the advertising product to consumers within their individual territories. Thus, through the plurality of franchised sales and distribution networks, a single geographically concentrated franchisor F/OR is able to distribute the unique direct advertising product over a wide geographical area.

The franchisee F/EE₁ . . . F/EEₙ supplies the franchisor F/OR with the franchisee's customer's information which is subsequently printed, at one or more locations P1, Pn by the franchisor F/OR, on a multi-page advertising product 1 as described herein and which is unique to the franchisee's geographical territory, one or more of the multi-page booklets 4 on each strip 2 being devoted to each individual customer, typically the retailers and the like R1 . . . Rn.

Due to the cost effective process of producing an on-line finished product 1 as described herein, a profit margin can be added to the cost of printing, thus netting a profit to the franchisor F/OR each time a print run is made. Further, due to the cost effectiveness of the consolidated and on-line finished printing process, including the profit margin to the franchisor F/OR, the franchisee F/EE₁ . . . F/EEₙ is able to generate a profit over and above the costs of printing and delivery through sales of direct marketing advertising to their individual customers R1 . . . Rn at an industry-acceptable cost.

The unique advertising product 1 is attractive to both the customer R1 . . . Rn, in this case the retailer, service provider and the like, and the consumer as the booklets 4 containing a plurality of coupons 5 and other advertising and promotional materials unique to a retailer R1 . . . Rn are subsequently torn from the strip 2 and can be easily retained by the consumer in the booklet 4 format.

Optionally, through use of the unique advertising product and the system disclosed herein the franchisor/licensor F/OR is able to collect information regarding the relative success of different coupon offers across a broad range of customers in a variety of retail markets over a wide range of geographical territories. Thus, the franchisor/licensor F/OR is capable of providing to the franchisees F/EE, and ultimately to the customers, information useful in establishing benchmarks of performance and in establishing future coupon offers and advertising strategies.

For example, in the fast food industry data regarding the relative success of a variety of coupon offers for a number of different food retailers, typically calculated as the number of coupons returned compared to those delivered and the revenue generated therefrom, is collected and averaged. The data from each retailer can then be compared to the average and the retailer can assess whether they believe their performance compared to the others in the group is as a result of their product, their service or their coupon offer. In the case of less than average performance, the data can be used to assist in selecting more successful coupon offers to be used in successive offers.

Further, the data can be used to assist retailers R who have not yet used coupons in their business or in a particular geographical area to determine what coupon offers overall are most successful and also if there is a bias in their geographical area or particular industry towards certain types of coupon offers. Thus, the retailer R is assisted in selecting a strategy which has a greater likelihood of success.

The embodiments of the invention in which an exclusive property or privilege is claimed are defined as follows:

1. A multi-page advertising medium comprising:
an elongate multi-page strip having an elongate spine edge and an elongate open edge, the strip formed having two or more discrete multi-page booklets, each discrete multi-page booklet of the two or more multi-page booklets being separated by a line of perforations formed through the strip transversely and substantially thereacross, each discrete multi-page booklet being removeable from an adjacent multi-page booklet at the line of perforations therebetween.

2. The multi-page advertising medium of claim 1 wherein each page of each of the multi-page booklets further comprises indicia printed thereon.

3. The multi-page advertising medium of claim 1 wherein each page of each of the multi-page booklets has a first side and a second side and further comprises indicia printed on each of the first and second side.

4. The multi-page advertising medium of claim 2 wherein the indicia is a coupon.

5. The multi-page advertising medium of claim 2 wherein the indicia on at least one of the first and second side is a coupon.

6. The multi-page advertising medium of claim 1 wherein the spine edge is a glued spine.

7. The multi-page advertising medium of claim 1 wherein each page of at least one of the plurality of multi-page booklets is related to a single advertiser.

8. The multi-page advertising medium of claim 1 wherein the plurality of multi-page booklets are related to a single type of advertiser.

9. The multi-page advertising medium of claim 1 further comprising an opening formed in at least a portion of the elongate strip so as to permit hanging the elongate strip from a projection.

10. The multi-page advertising medium of claim 9 further comprising a top portion in which the opening is formed.

11. The multi-page advertising medium of claim 9 wherein the opening permits hanging the elongate strip on a projection.

12. A method for producing a multi-page advertising medium according to claim 1 comprising:
printing stock on at least one side,
perforating the stock transversely across a width of the stock at predetermined spaced intervals;
applying a first line of an adhesive longitudinally along a length of the stock at a position substantially a width of a booklet from a first longitudinal edge of the stock;
folding the stock along substantially in half for forming a folded multi-page stock having pages adhesively bonded at the first line of adhesive;
finish folding the folded multi-page stock in half for forming a finish-folded multi-page stock having a spine edge substantially along the line of adhesive opposing the first longitudinal edge, the finish-folded multi-page stock being substantially the width of a booklet; and
trimming the finish-folded multi-page stock longitudinally along the first longitudinal edge for opening the pages of the multi-page stock.

13. The method of claim 12 further comprising:
printing the stock at each of a plurality of predetermined spaced intervals, the printing extending transversely across the width of the stock so as to be between the perforations for forming discrete booklets.

14. The method of claim 12 wherein the stock is a substantially continuous web stock, the method following the trimming step, further comprising:
severing predetermined lengths from the stock for forming strips, each strip having a plurality of discrete multi-page booklets thereon, each discrete multi-page booklet being removeable from an adjacent multi-page booklet on the strip at the line of perforations therebetween.

15. The method of claim 12 wherein the stock is a substantially continuous web stock further comprising:
perforating the stock prior to folding the stock.

16. The method of claim 12 wherein the stock is sheet stock further comprising:
perforating the stock after finish folding the stock and prior to the trimming step.

17. The method of claim 12 wherein a greater number of pages are formed from stock having a greater width, the method further comprising:
repeating the applying the adhesive, and folding steps until the width of the folded stock is substantially the width of two booklets prior to performing the finish folding step.

18. The method of claim 12 wherein following the printing, the remaining steps are performed in an on-line finishing process.

19. The method of claim 12 further comprising forming a shaped opening thorugh a top of the finished multi-page stock before the trimming step, adapted to permit hanging the multi-page advertising medium on a projection.

20. The method of claim 19 wherein forming the shaped opening is by die-cutting.

21. The method of claim 14 further comprising forming a shaped opening through a top of each predetermined length of finish-folded stock prior to the severing step, adapted to permit hanging the multi-page advertising medium on a projection.
